(19) United States
(12) Patent Application Publication
(10) Pub. No.: US 2010/0049920 A1
(43) Pub. Date: Feb. 25, 2010

(54) DYNAMICALLY ADJUSTING WRITE CACHE SIZE

(75) Inventors: Lee C. LaFrese, Tucson, AZ (US); Christopher M. Sansone, Tucson, AZ (US); Dana F. Scott, Tucson, AZ (US); Yan Xu, Tucson, AZ (US); Olga Yiparaki, Tucson, AZ (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/194,614

(22) Filed: Aug. 20, 2008

(51) Int. Cl. G06F 12/08

(52) U.S. Cl. 711/118; 711/E12.041; 711/E12.017

(57) ABSTRACT

A storage system includes a backend storage unit for storing electronic information; a controller unit for controlling reading and writing to the backend storage unit; and at least one of a cache and a non-volatile storage for storing the electronic information during at least one of the reading and the writing; the controller unit executing machine readable and machine executable instructions including instructions for: testing if a frequency of non-volatile storage full condition has occurred one of above and below an upper threshold frequency value and a lower threshold frequency value; if the frequency of the condition has exceeded a threshold frequency value, then calculating a new size; calculating an expected average response time for the new size; comparing actual response time to the expected response time; and one of adjusting and not adjusting a size of the non-volatile storage to minimize the response time.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Field of the Invention

The invention disclosed herein relates to processing systems, and in particular, to a storage system that dynamically adjusts a size of a write cache.

2. Description of the Related Art

A write cache or a non-volatile storage (NVS) is used to improve performance of writing data from a host to a storage control unit. There may be times when NVS utilization is high due to increased write activity from the host.

With the current non-volatile memory management algorithm, when there is enough non-volatile memory available, host writes are serviced within a few milliseconds. When the non-volatile memory is full, host writes will be “on hold” indefinitely, until there is enough non-volatile memory available to write the data from memory. When there is an increased number of host writes, the host input and output may experience long write response times.

What are needed are methods and apparatus for reducing write times when non-volatile storage (NVS) is full.

### BRIEF SUMMARY

The shortcomings of the prior art are overcome and additional advantages are provided through the provision of a storage system that includes a backend storage unit for storing electronic information; a controller unit for controlling reading and writing to the backend storage unit; and at least one of a cache and a non-volatile storage for storing the electronic information during at least one of the reading and the writing; the controller unit executing machine readable and machine executable instructions including instructions for: testing if a frequency of non-volatile storage full condition has occurred one of above and below an upper threshold frequency value and a lower threshold frequency value; if the frequency of the condition has exceeded a threshold frequency value, then calculating a new size; calculating an expected average response time for the new size; comparing actual response time to the expected response time; and one of adjusting and not adjusting a size of the non-volatile storage to minimize the response time.

System and computer program products corresponding to the above-summarized methods are also described herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a processing system that makes use of a storage system as disclosed herein;

FIG. 2 illustrates aspects of an architecture for the storage system disclosed herein;

FIG. 3 illustrates one example of an algorithm for storing data.

The detailed description explains the preferred embodiments of the invention, together with advantages and features, by way of example with reference to the drawings.

### DETAILED DESCRIPTION

Disclosed are aspects of a storage system useful for supporting a processing system. The storage system includes a cache and improves performance of writes of the processing system by storing data in non-volatile memory first and then later writing to the data to backend storage asynchronously.

The storage system includes an algorithm that provides for efficient storing of data. The algorithm is designed to address circumstances when non-volatiles storage (NVS) is full, or nearly full, too frequently. Many storage architecture designs have a fixed size NVS and a fixed size cache. By dynamically adjusting the NVS-to-Cache-ratio as disclosed herein, the overall system performance can be improved.

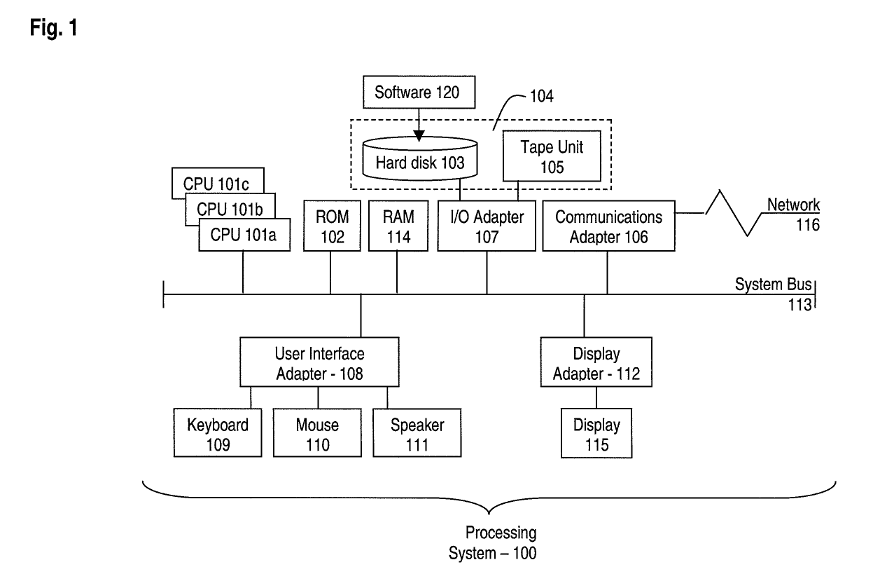

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing means in the form of processors 101, storage means including system memory 114 and mass storage 104, input means such as keyboard 109 and mouse 110, and output means including speaker 111 and display 115. In one embodiment, a portion of system memory 114 and mass storage 104 collectively store an operating system such as the AIX® operating system from IBM Corporation to coordinate the functions of the various components shown in FIG. 1.

It will be appreciated that the system 100 can be any suitable computer or computing platform, and may include a terminal, wireless device, information appliance, device, workstation, mini-computer, mainframe computer, personal digital assistant (PDA) or other computing device.

Examples of operating systems that may be supported by the system 100 include Windows 95, Windows 98, Windows NT 4.0, Windows XP, Windows 2000, Windows CE, Windows Vista, Macintosh, Java, LINUX, and UNIX, or any other suitable operating system. The system 100 also includes a network interface 106 for communicating over a network 116. The network 116 can be a local-area network (LAN), a metro-area network (MAN), or wide-area network (WAN), such as the Internet or World Wide Web, or any other type of network 116.

Users of the system 100 can connect to the network 116 through any suitable network interface 106 connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

Of course, the processing system 100 may include fewer or more components as are or may be known in the art or later devised.

As disclosed herein, the processing system 100 includes machine readable instructions stored on machine readable media (for example, the hard disk 103). As discussed herein, the instructions are referred to as “software” 120. The software 120 may be produced using software development tools as are known in the art.

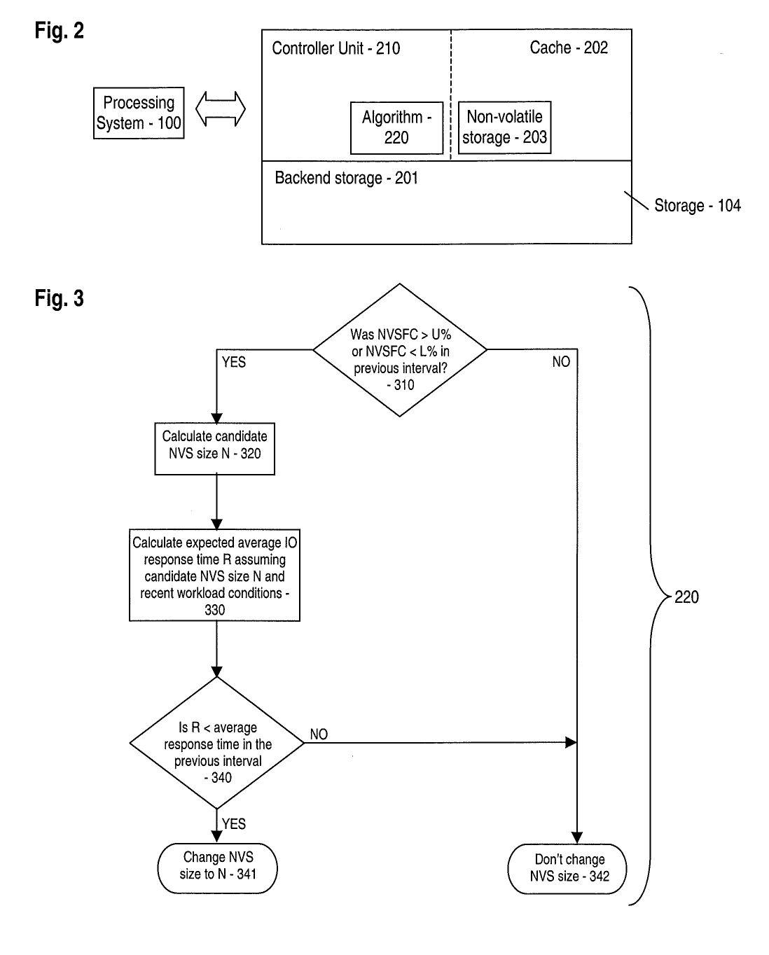

With reference to FIG. 2, the mass storage 104, or simply storage 104, may include any type of a variety of devices used for storing software 120, data and the like. Generally, each device provided as the storage 104 includes a controller unit 210, a cache 202, and a backend storage 201. Non-volatile storage 203 (i.e., memory) may be included as an aspect of the controller unit 210, or otherwise included within the storage 104. The backend storage 201 generally includes media for storing at least one of software 120, data and other information as electronic information.

As is known in the art, the controller unit 210 generally includes an algorithm 220 as instructions for controlling operation of the storage 104. The instructions may be included in firmware (such as within read-only-memory (ROM)) on board the controller unit 210, as an built-in-operating-system for the storage 104 (such as software that loads to memory of the controller unit 210 when powered on), or by other techniques known in the art for including instructions for controlling the storage unit 104.

In general, the algorithm 220 enhancement minimizes a probability of hitting long host write response times. The algorithm 220 varies a size of the non-volatile storage 203 to accommodate a current workload of the processing system 100. It is important to note that if the non-volatile storage 203 is increased, an amount of cache 202 available to the storage 104 for read data will be decreased. The algorithm 220 may determine the correct size of the non-volatile storage 203 based on the past history of the system. Specifically, and as an example, the algorithm 220 may use a “non-volatile memory full” condition as a trigger. If the “non-volatile memory full” condition occurs at a frequency that is beyond a specified upper bound or a lower bound, then the algorithm 220 will determine if an adjustment is needed. The algorithm 220 will use, for example, the past performance history for the storage system 104 with the current setting for size of the non-volatile storage 203 to determine a new size for the non-volatile storage 203. This will allow the storage system 104 to adjust to the new write demand and use the internal resources of the system more efficiently. Aspects of the algorithm 220 are shown in FIG. 3.

In FIG. 3, when the algorithm 220 is invoked, in a first stage 310, a test is performed. The test ascertains if the “non-volatile memory full” condition has occurred at a frequency that is beyond a specified upper bound or a lower bound. If the answer is yes, then in a second stage 320, a new size for the non-volatile storage 203 is calculated. In a third stage 330, an expected average response time, R, is calculated. In a fourth stage 340, if the calculated average response time, R, is less then the actual response time, then in a fifth stage 341, the size of the non-volatile storage 203 is changed. If not, the size of the non-volatile storage 203 is not changed (in a sixth step 342).

As an example, in further embodiments, initially, data is collected for a minimum of eight days while a size of the NVS 203 is held constant, according to an ideal initial configuration. Data is kept for the most recent n days, where n≧30. Data is collected and includes, for example, read and write response time, data transfer size, read and write ratio, and the NVS-full condition (NVSFC). The trigger for adjusting the size of the NVS 203 size up or down, such as if NVSFC was encountered more than U % of the time or less than L % of the time, respectively. In one embodiment, recommended defaults for these values are: U=1 and L=0:3. For a given read:write ratio, consider a histogram of the corresponding response times which do not have NVSFC associated with them. Let w* be the average write response time of the “middle” 80% of the response time histogram (discarding the top and bottom 10% as outliers). Then, let w=w* ((current xfer size)/(table's xfer size)). Let c be the current write response time. If R_{new}<R_{current}, then let NV S_{new}=min(NVS_{old} (c/w),NVSₘₐₓ); where R_{new}=c*p(Wr)+t_{RH}*pₑₓₚ(RH)+t_{RM}*pₑₓₚ(RM), and where the expected values of these probabilities are calculated based on a preferred benchmark, the user's workload characteristics, or on other similar bases. If the table does not have data without NVSFC, the increase the NVS size by 30% for the next interval. Of course, other relationships, embodiments of algorithms, setpoints and such may be used for managing the non-volatile storage. Accordingly, the foregoing are merely exemplary embodiments and are non-limiting of the teachings herein.

As one might imagine, the teachings herein are applied in a storage system where it is possible to convert cache memory to non-volatile write cache.

The capabilities of the present invention can be implemented in software, firmware, hardware or some combination thereof

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A storage system comprising:
a backend storage unit for storing electronic information; a controller unit for controlling reading and writing to the backend storage unit; and at least one of a cache and a non-volatile storage for storing the electronic information during at least one of the reading and the writing; the controller unit executing machine readable and machine executable instructions comprising instructions for:
testing if a frequency of non-volatile storage full condition has occurred one of above and below an upper threshold frequency value and a lower threshold frequency value;
if the frequency of the condition has exceeded a threshold frequency value, then calculating a new size;
calculating an expected average response time for the new size;
comparing actual response time to the expected response time; and
one of adjusting and not adjusting a size of the non-volatile storage to minimize the response time.
